(19) United States
(12) Patent Application Publication
(10) Pub. No.: US 2005/0137827 A1
(43) Pub. Date: Jun. 23, 2005

(54) System and method for managing arrangement position and shape of device

(75) Inventor: Takeshi Takamiya, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/979,156

(22) Filed: Nov. 3, 2004

(30) Foreign Application Priority Data
Dec. 22, 2003 (JP) 2003-425036

(51) Int. Cl. G01C 17/00

(52) U.S. Cl. 702/150

(57) ABSTRACT

A system includes a first sensor, a second sensor and a third sensor, each of the sensors being configured to detect a distance from each of electronic devices that are present in a space and an identifier of each of the electronic devices by using a wireless signal, and a host apparatus that executes communication with each of the sensors, the host apparatus including a detection unit that detects a position of each of the electronic devices in the space, based on the distance from each of the electronic devices and a position of each of the first sensor, second sensor and third sensor in the space, and a unit that acquires shape information representative of a shape of each of the electronic devices from each of the electronic devices, by executing wireless communication with each of the electronic devices using the identifier of each of the electronic devices.

### CROSS-REFERENCE TO RELATED APPLICATIONS

This application is based upon and claims the benefit of priority from prior Japanese Patent Application No. 2003-425036, filed Dec. 22, 2003, the entire contents of which are incorporated herein by reference.

### BACKGROUND OF THE INVENTION

1. Field of the Invention

The present invention relates to a device management system for managing the arrangement positions and shapes of devices that are present in facilities such as an office or a factory.

2. Description of the Related Art

In general, various electronic devices, such as personal computers, server computers, printers and facsimiles, are used in facilities such as offices and factories. In houses, too, various electronic devices, such as personal computers, TVs, video recorders, refrigerators and microwave ovens, are used.

Jpn. Pat. Appln. KOKAI Publication No. 2003-177980 discloses an information providing system that provides a mobile terminal with information (kinds of devices, services associated with devices) relating to devices that are present in a room. In this information providing system, a directory server is used. The directory server prestores information relating to each of devices that are present in respective rooms. Based on position information that is sent from the mobile terminal, the directory server provides the mobile terminal with information relating to each of devices that are present in a room where the mobile terminal is currently present.

In facilities such as offices and factories, however, the locations where the electronic devices are arranged vary greatly with time because of, for instance, a change in layout of in rooms, or a change of personnel. Thus, it is a difficult work for a facility manager to exactly understand where the individual electronic devices are actually present.

In particular, in a warehouse where many electronic devices are stored, a great deal of time and labor is required in order to search for an electronic device, since the locations of individual electronic devices in the warehouse and the shapes of the electronic devices are not understandable.

Under the circumstances, there is a need to realize a function for managing the actual locations of individual electronic devices.

### BRIEF SUMMARY OF THE INVENTION

According to an aspect of the present invention, there is provided a system comprising: a first sensor, a second sensor and a third sensor, each of the sensors being configured to detect a distance from each of electronic devices that are present in a space and an identifier of each of the electronic devices by using a wireless signal; and a host apparatus that executes communication with each of the first sensor, second sensor and third sensor, the host apparatus including: a detection unit configured to detect a position of each of the electronic devices in the space, based on the distance from each of the electronic devices, which is detected by the first sensor, second sensor and third sensor, and a position of each of the first sensor, second sensor and third sensor in the space; and an information acquisition unit configured to acquire shape information representative of a shape of each of the electronic devices from each of the electronic devices, by executing wireless communication with each of the electronic devices using the identifier of each of the electronic devices, which is detected by the first sensor, second sensor and third sensor.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a device management system according to an embodiment of the present invention;

FIG. 2 is a block diagram showing the structure of an electronic device that is used in the device management system according to the embodiment;

FIG. 3 is a diagram for explaining how the position of each electronic device is detected in the device management system according to the embodiment;

FIG. 4 is a flow chart illustrating the operation of each sensor provided in the device management system according to the embodiment;

FIG. 5 is a flow chart illustrating the operation of a host apparatus provided in the device management system according to the embodiment;

FIG. 6 is a flow chart illustrating an example of a layout-view automatic production process procedure that is executed by the device management system according to the embodiment;

FIG. 7 shows an example of a layout screen that is produced by the device management system according to the embodiment;

FIG. 8 illustrates a state in which a master acquires self-data of a slave in the device management system according to the embodiment; and

FIG. 9 is a flow chart illustrating the operation of the master shown in FIG. 8.

### DETAILED DESCRIPTION OF THE INVENTION

An embodiment of the present invention will now be described with reference to the accompanying drawings.

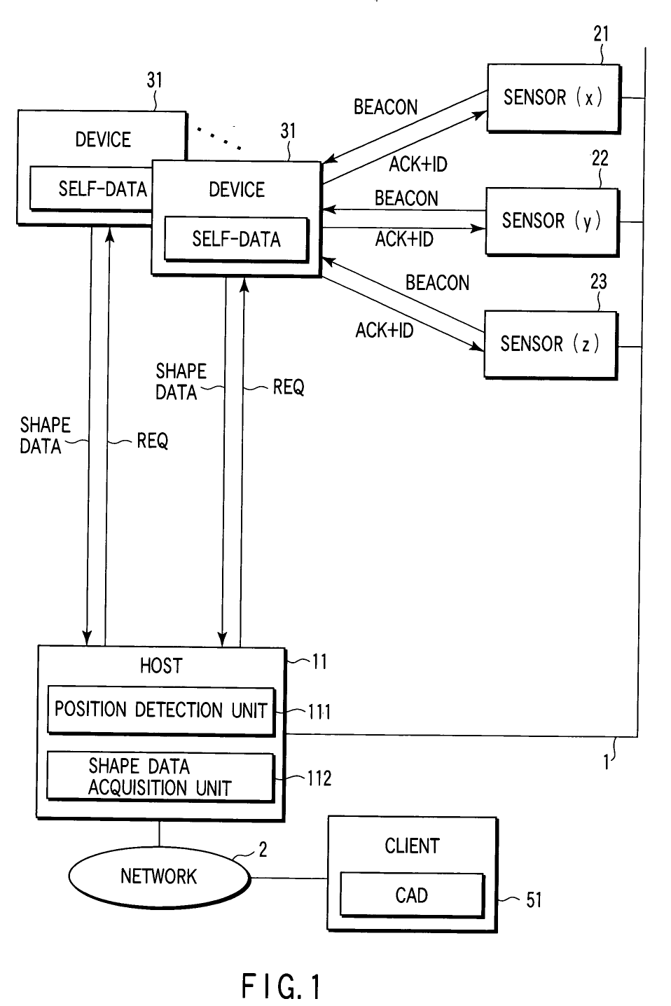

FIG. 1 shows the configuration of a device management system according to an embodiment of the invention. This device management system is a system for recognizing the arrangement positions of individual electronic devices, which are present in a space to be managed, and the shapes of the individual electronic devices. The to-be-managed space is, for instance, a room or a warehouse that is present in facilities such as an office or a factory. The device management system includes a host apparatus 11 and three (first to third) sensors 21, 22 and 23.

The three sensors 21, 22 and 23 are a sensor group for detecting the arrangement positions of the individual electronic devices in the three-dimensional (3D) to-be-managed space. The sensors 21, 22 and 23 are discretely arranged at predetermined positions within the 3D to-be-managed space. For example, the first sensor 21 is disposed at a predetermined position on the X coordinate axis of an XYZ coordinate system defined in the 3D to-be-managed space. The second sensor 22 is disposed at a predetermined position on the Y coordinate axis, and the third sensor 23 is disposed at a predetermined position on the Z coordinate axis. Each of the sensors 21, 22 and 23 detects a distance between the position thereof and the respective electronic devices that are present in the 3D to-be-managed space by using a wireless signal such as an acoustic wave or an electromagnetic wave (“distance measurement”).

In the 3D to-be-managed space, a plurality of devices 31 are arranged. Each device 31 is an electronic device such as a personal computer, a server computer, a printer, a facsimile, a TV, or a video recorder. Each device 31 stores self-data that is indicative of its own attributes. The self-data includes a device identifier (device ID) and shape data that is indicative of the shape of the device. Further, each device 31 includes a wireless communication unit.

The sensor 21 broadcast-transmits, e.g. a beacon signal within the to-be-managed space and uses a response signal (ACK) to the beacon signal, thereby detecting the device ID of each device 31, and a distance between each device 31 and the sensor 21. Specifically, the sensor 21 measures an elapsed time (response time) from when the beacon signal is transmitted to when the response signal (ACK) is received. The sensor 21 detects the measured response time as the distance. The beacon signal is a polling signal for searching for the devices. The response signal (ACK) from each device 31 includes the device ID thereof. If each device sends a response signal (ACK) including a time stamp that indicates a transmission time of the response signal (ACK), the sensor 21 can detect, as the distance, the difference between the time point indicated by the time stamp and the time point when the response signal (ACK) is received.

Each of the sensors 22 and 23 has the same structure as the sensor 21. Specifically, the sensor 22 broadcast-transmits a beacon signal within the to-be-managed space and uses a response signal (ACK) to the beacon signal, thereby detecting the device ID of each device 31 and a distance between each device 31 and the sensor 22. In this case, the sensor 22 measures a time (response time) from a time when the beacon signal is transmitted to a time when the response signal (ACK) is received, and detects the measured response time as the distance. Similarly, the sensor 23 broadcast-transmits a beacon signal within the to-be-managed space and uses a response signal (ACK) to the beacon signal, thereby detecting the device ID of each device 31 and a distance between each device 31 and the sensor 23. In this case, the sensor 23 measures an elapsed time (response time) from when the beacon signal is transmitted to when the response signal (ACK) is received, and detects the measured response time as the distance.

If each device 31 sends a response signal (ACK) including a time stamp that indicates a transmission time of the response signal (ACK), each of the sensors 22 and 23, like the sensor 21, can detect, as the distance, the difference between the time point indicated by the time stamp and the time point when the response signal (ACK) is received.

The sensors 21, 22 and 23 transmit beacon signals in a predetermined order. For example, the sensor 21 first transmits the beacon signal. After a predetermined time period, the sensor 22 transmits the beacon signal. Further, after a predetermined time period, the sensor 23 transmits the beacon signal.

The host apparatus 11 is connected to the sensors 21, 22 and 23 via, e.g. a wired or wireless network 1. The host apparatus 11 executes communications with the sensors 21, 22 and 23 via the network 1, thereby to control the operations of the sensors 21, 22 and 23. In addition, using the device IDs detected by the sensors 21, 22 and 23, the host apparatus 11 executes wireless communication with each of the devices 31 that are present in the 3D to-be-managed space.

The host apparatus 11 includes a position detection unit 111 and a shape data acquisition unit 112. The position detection unit 111 detects a position in the to-be-managed space, where each device 31 is disposed, on the basis of the distance from each device 31, which is detected by the sensor 21, 22, 23, and the positions of the sensor 21, 22, 23 in the 3D to-be-managed space. The shape data acquisition unit 112 executes wireless communication with each device 31, and acquires shape data from each device 31. The wireless communication between the shape data acquisition unit 112 and each device 31 is executed using the device ID that is detected by the sensor 21, 22, 23. If the sensors 21, 22 and 23 detect two devices ID #1 and ID #2, the shape data acquisition unit 112 transmits a shape data acquisition request (REQ) including the device ID #1 as a destination address, and acquires shape data from the device 31 that is designated by the device ID #1. Further, the shape data acquisition unit 112 transmits a shape data acquisition request (REQ) including the device ID #2 as a destination address, and acquires shape data from the device 31 that is designated by the device ID #2.

The host apparatus 11 is connected to a client terminal 51 via a wired or wireless network 2. The client terminal 51 is realized by, e.g. a personal computer. In the client terminal 51, a design support program, such as CAD (computer-aided design) software, is preinstalled. The design support program has a function of automatically producing a layout view that shows the arrangement position and the shape of each device 31 in the to-be-managed space, on the basis of the position of each device detected by the host apparatus 11 and the shape data of each device acquired by the host apparatus 11. This layout-view automatic production function may be provided in the host apparatus 11.

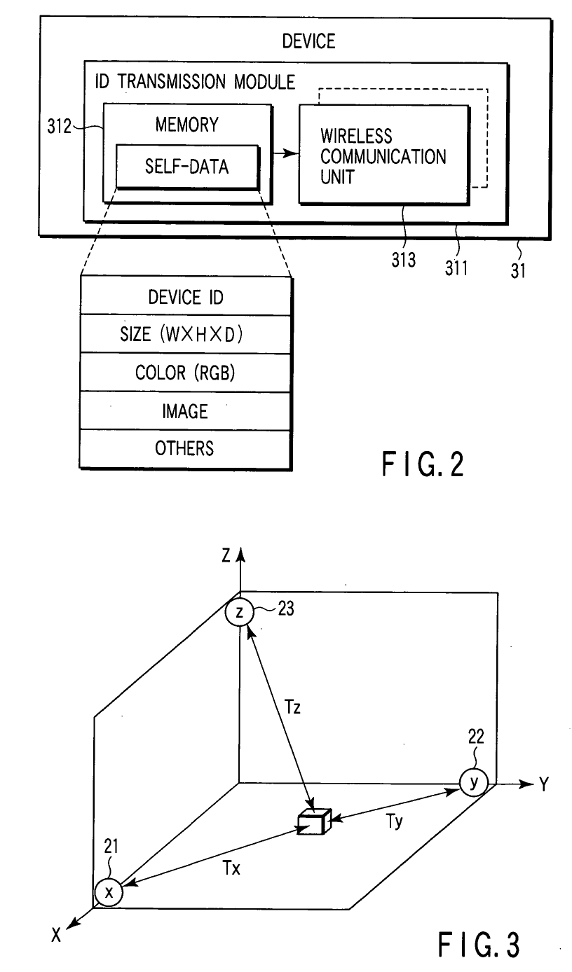

FIG. 2 shows the structure of each device 31.

Each device 31 has housing and an ID transmission module 311 in order to realize cooperation with the device management system of the present embodiment. The ID transmission module 311 is a module that is attachable/detachable to/from the housing of the associated device 31. For example, the ID transmission module 311 is realized as a card. The card that constitutes the ID transmission module 311 includes a memory 312 and a wireless communication unit 313.

The memory 312 comprises, e.g. a nonvolatile memory, which stores self-data. The self-data includes, in addition to the device ID of the associated device 31, size data (W×H×D) indicative of the size and shape of the housing of the device 31, color data (RGB) indicative of the color, and image data of the housing of the device 31. The size data (W×H×D), color data (RGB) and image data are used as shape data of the device 31. The image data is, for instance, image data representative of the texture of the surface of the housing of the device 31, or a photo image that is obtained by imaging the device 31. Additionally, information indicative of the weight of the device 31 may be stored in the memory 312 as information that is included in the self-data.

The wireless communication unit 313 executes wireless communication with the outside. If the wireless communication scheme for communication between the device 31 and each sensor 21, 22, 23 is different from the wireless communication scheme for communication between the device 31 and the host apparatus 11, the ID transmission module 311 is equipped with two kinds of wireless communication units 313.

Referring now to FIG. 3, how to detect the position of the device 31 is described.

As is shown in FIG. 3, the sensors 21, 22 and 23 are disposed on known positions on the X, Y and Z axes of the 3D coordinate system that is defined in a room. For example, the position of the sensor 21 is (x, 0, 0), the position of the sensor 22 is (0, y, 0), and the position of the sensor 23 is (0, 0, z).

The sensor 21 detects a time (response time Tx) from a time when the sensor 21 transmits a beacon signal to a time when the sensor 21 receives a response signal (ACK) from the device 31, and detects the response time Tx as the distance between the sensor 21 and the device 31. Conversion from the response time Tx to a physical distance value is executed by, e.g. the position detection unit 111. The position detection unit 111 converts the response time Tx to a value indicative of the physical distance between the sensor 21 and device 31, on the basis of the value of the propagation speed of a wireless signal that is used for the wireless communication between the sensor 21, 22, 23 and each device 31. For example, the physical distance is given by multiplying the value of ½ of the response time Tx by the value of the propagation speed of the wireless signal.

The sensor 22 measures an elapsed (response time Ty) from when the sensor 22 transmits the beacon signal to when the sensor 22 receives the response signal (ACK), and detects the measured response time Ty as the distance between the sensor 22 and the device 31. Conversion from the response time Ty to a physical distance value is executed on the basis of the value of the propagation speed of a wireless signal that is used for the wireless communication between the sensor 21, 22, 23 and each device 31.

The sensor 23 measures an elapsed (response time Tz) from when the sensor 23 transmits the beacon signal to when the sensor 23 receives the response signal (ACK), and detects the measured response time Tz as the distance between the sensor 23 and the device 31. Conversion from the response time Tz to a physical distance value is executed on the basis of the value of the propagation speed of a wireless signal that is used for the wireless communication between the sensor 21, 22, 23 and each device 31.

The sensors 21, 22 and 23 are disposed at the known positions. Thus, the position (x, y, z) of each device 31 in the 3D space can be specified by detecting the distance s between the sensor 21, 22, 23 and each device 31.

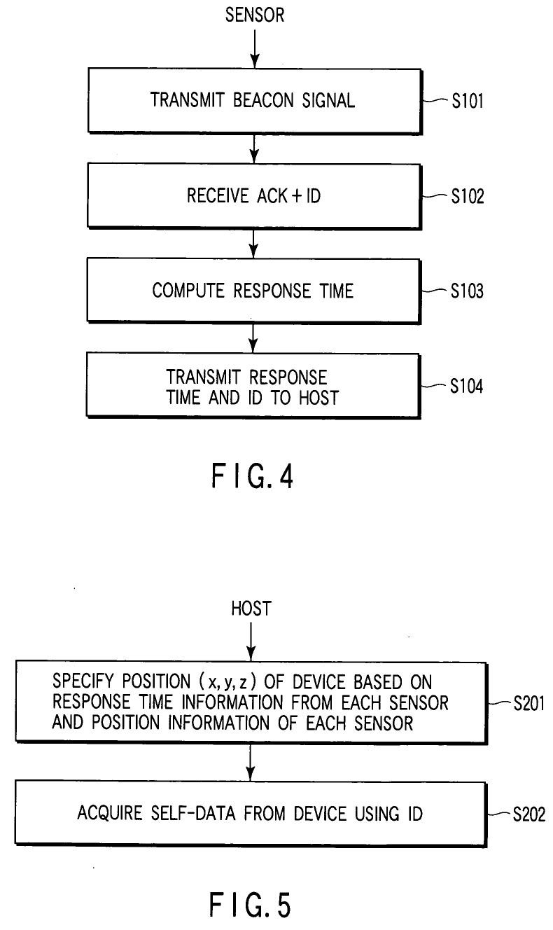

Next, referring to a flow chart of FIG. 4, the operation that is executed by each sensor 21, 22, 23 is described.

The each of sensors 21, 22, 23 broadcast-transmits a beacon signal for searching for the device 31 in the to-be-managed space (step S101). The device 31, which receives the beacon signal, sends a response signal (ACK) with the device ID to the sensor from which the beacon signal is transmitted. Upon receiving the response signal (ACK) (step S102), each sensor 21, 22, 23 calculates the response time from a time when the beacon is transmitted to a time when the response signal (ACK) is received, as the distance between the sensor and the device 31 that transmits the response signal (ACK) (step S103).

Subsequently, the each of sensors 21, 22, 23 sends the response time and the device ID included in the received response signal (ACK) to the host apparatus 11 (step S104). Thereby, with respect to each ID, three response times associated with the sensors 21, 22 and 23 are delivered to the host apparatus 11.

Next, referring to a flow chart of FIG. 5, the operation that is executed by the host apparatus 11 is described.

If the host apparatus 11 receives the three response times from the sensors 21, 22 and 23 in association with the same device ID, the host apparatus 11 executes a process for specifying the position of the device associated with this device ID (step S201). In step S201, the host apparatus 11 converts the response time Tx detected by the sensor 21, the response time Ty detected by the sensor 22 and the response time Tz detected by the sensor 23 to physical distance values. Based on the three distance values obtained by the conversion and the arrangement positions of the sensors 21, 22 and 23, the host apparatus 11 computes the position (x, y, z) of the device.

Thereafter, the host apparatus 11 transmits a shape information acquisition request to the device that is designated by each of the device IDs received from the sensors 21, 22 and 23. Thus, the host apparatus 11 receives self-data including shape information from each device designated by the associated device ID (step S202).

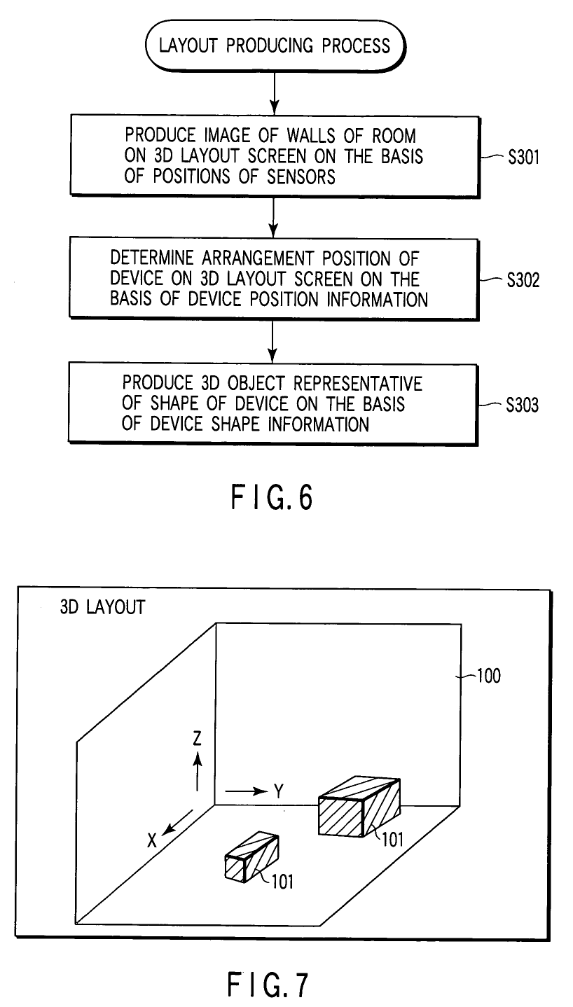

Referring to a flow chart of FIG. 6, a description is given of the layout-view automatic production process that is executed by the client terminal 51.

Upon receiving the position information and shape information of each device 31 from the host apparatus 11, the client terminal 51 executes the following process.

The client terminal 51 generates an image of walls of a room on a 3D layout screen, on the basis of the positions of the sensors 21, 22 and 23 in the 3D space (step S301). The 3D layout screen is a 3D drawing screen that is provided by the CAD software. In step S301, an image 100 of the 3D walls is drawn, as shown in FIG. 7.

Next, the client terminal 51 determines the position of each device 31 on the 3D layout screen, on the basis of the position information of each device 31 (step S302). Then, based on the shape information of each device 31, the client terminal 51 generates 3D objects 101 that represent the shapes of the respective devices, and arranges the 3D objects 101 at associated positions on the 3D layout screen, as shown in FIG. 7 (step S303). The surfaces of the 3D object 101 are painted with colors that are designated by the shape information.

By viewing the 3D layout screen, the facility manager can easily understand where the respective devices are located, and what shapes they have.

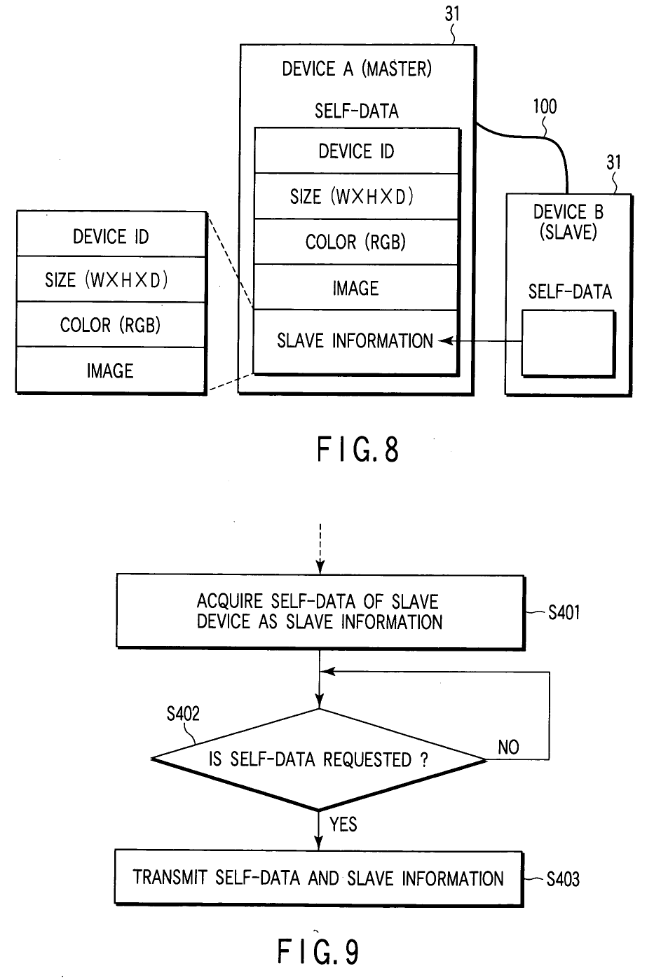

Referring now to FIG. 8, a description is given of a process for acquiring self-data of mutually associated devices at a time, from a certain one of the mutually associated devices.

In general, many devices are mutually associated in operation. One of mutually associated devices (e.g. a personal computer and a printer connected to the personal computer; or a TV and a video recorder connected to the TV) functions as a master, and the other as a slave. In FIG. 8, a device (A) 31 and a device (B) 31 are connected by a cable 100 such as a USB cable. The device (A) 31 functions as a master, and the device (B) 31 as a slave. The device (A) 31 and device (B) 31 are disposed close to each other.

The device (A) 31 acquires self-data stored in the device (B) 31 from the device (B) 31 over the cable 100. The device (A) 31 adds the acquired self-data to its own self-data as slave information indicative of a peripheral device of the device (A) 31. The device (B) 31 does not respond to the beacon signal, and only the device (A) 31 responds to the beacon signal. The device ID and position of the device (A) 31 alone are detected, and the device ID and position of the device (B) 31 are not detected.

The operation that is executed by the device (A) 31 is described with reference to a flow chart of FIG. 9.

As described above, the device (A) 31 acquires self-data stored in the device (B) 31 from the device (B) 31 over the cable 100, and adds the acquired self-data to its own self-data as slave information indicative of a peripheral device of the device (A) 31 (step S401). Upon receiving the shape data acquisition request (REQ) including the device ID of the device (A) 31 from the host apparatus 11, the device (A) 31 transmits both of its own self-data and the slave information to the host apparatus 11 (step S403). Only by executing communication with the device (A) 31, the host apparatus 11 can recognize not only the shape of the device (A) 31, but also the presence of a peripheral device near the device (A) 31 and the shape of the peripheral device. Thereby, the host apparatus 11 can recognize the positions and shapes of the individual devices in the to-be-managed space with a less number of times of communication.

As has been described above, according to the device management system of the present embodiment, it becomes possible to exactly recognize the arrangement positions and shapes of electronic devices in a space such as a room or a warehouse. This system can efficiently support works such as inventory management in a warehouse, preparation for a move, a change of layout in a room, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A system comprising:
a first sensor, a second sensor and a third sensor, each of the sensors being configured to detect a distance from each of electronic devices that are present in a space and an identifier of each of the electronic devices by using a wireless signal; and
a host apparatus that executes communication with each of the first sensor, second sensor and third sensor, the host apparatus including:
a detection unit configured to detect a position of each of the electronic devices in the space, based on the distance from each of the electronic devices, which is detected by the first sensor, second sensor and third sensor, and a position of each of the first sensor, second sensor and third sensor in the space; and
an information acquisition unit configured to acquire shape information representative of a shape of each of the electronic devices from each of the electronic devices, by executing wireless communication with each of the electronic devices using the identifier of each of the electronic devices, which is detected by the first sensor, second sensor and third sensor.

2. The system according to claim 1, wherein each of the first sensor, second sensor and third sensor includes a unit that transmits a beacon signal for searching for electronic devices that are present in the space, and a unit that informs the host apparatus of time information, which is indicative of an elapsed time from when the beacon signal is transmitted to when a response signal is received from each of the electronic devices in the space, as a distance from each of the electronic devices.

3. The system according to claim 2, wherein the detection unit is configured to convert the time information, which is transmitted from each of the first sensor, second sensor and third sensor, to a distance between each of the first sensor, second sensor and third sensor and each of the electronic devices, in accordance with a propagation speed of the wireless signal that is used for communication between each of the first sensor, second sensor and third sensor and each of the electronic devices.

4. The system according to claim 1, wherein each of the electronic devices includes a memory unit that stores the shape information of the electronic device.

5. The system according to claim 4, wherein each of the electronic devices functions as one of a master and a slave, and the electronic device functioning as the master includes a unit that acquires from the other electronic device, which functions as the slave of the electronic device functioning as the master, the shape information of the other electronic device as slave information, and a unit that transmits the shape information stored in the memory unit and the acquired slave information to the host apparatus in response to a request from the host apparatus.

6. The system according to claim 1, further comprising:
a layout-view production unit that produces a layout view showing an arrangement position and the shape of each of the electronic devices in the space based on the detected position of each of the electronic devices and the acquired shape information of each of the electronic devices.

7. A system comprising:
an electronic device including a housing, a memory unit that stores shape information indicative of a shape of the housing, and a wireless communication unit that executes wireless communication with outside;
a first sensor, a second sensor and a third sensor, which are discretely arranged in a space, each of the sensors being configured to detect a distance from the electronic device that is present in the space and an identifier of the electronic device by using a wireless signal; and
a host apparatus that executes communication with each of the first sensor, second sensor and third sensor, the host apparatus including a detection unit that detects a position of the electronic device in the space, based on the distance from the electronic device, which is detected by the first sensor, second sensor and third sensor, and a position of each of the first sensor, second sensor and third sensor in the space; and an information acquisition unit that acquires shape information representative of a shape of the electronic device from the electronic device, by executing wireless communication with the electronic device using the identifier detected by the first sensor, second sensor and third sensor.

8. The system according to claim 1, wherein the memory unit and the wireless communication unit are included in a module that is detachably attached to the housing of the electronic device.

9. A system comprising:
a first sensor, a second sensor and a third sensor, each of the sensors being configured to detect a distance from each of electronic devices that are present in a space and an identifier of each of the electronic devices by using a wireless signal; and
means for detecting a position of each of the electronic devices in the space, based on the distance from each of the electronic devices, which is detected by the first sensor, second sensor and third sensor, and a position of each of the first sensor, second sensor and third sensor in the space; and
means for acquiring shape information representative of a shape of each of the electronic devices from each of the electronic devices, by executing wireless communication with each of the electronic devices using the identifier of each of the electronic devices, which is detected by the first sensor, second sensor and third sensor.

10. The system according to claim 9, wherein each of the first sensor, second sensor and third sensor includes a unit that transmits a beacon signal for searching for electronic devices that are present in the space, and a unit that informs a host apparatus of time information, which is indicative of an elapsed time from when the beacon signal is transmitted to when a response signal is received from each of the electronic devices in the space, as a distance from each of the electronic devices.

11. The system according to claim 10, wherein the detection means includes means for converting the time information, which is transmitted from each of the first sensor, second sensor and third sensor, to a distance between each of the first sensor, second sensor and third sensor and each of the electronic devices, in accordance with a propagation speed of the wireless signal that is used for communication between each of the first sensor, second sensor and third sensor and each of the electronic devices.

12. The system according to claim 9, wherein each of the electronic devices includes a memory unit that stores the shape information of the electronic device.
